(19) United States
(12) Patent Application Publication
(10) Pub. No.: US 2001/0007475 A1
(43) Pub. Date: Jul. 12, 2001

(54) Image pickup device and its mounting structure for an optical low-pass filter

(75) Inventor: Makoto Mogamiya, Tokyo (JP)

Correspondence Address: GREENBLUM & BERNSTEIN, 1941 ROLAND CLARKE PLACE, RESTON, VA, 20191

(73) Assignee: ASAHI KOGAKU KOGYO KABUSHIKI KAISHA

(21) Appl. No.: 09/749,667

(22) Filed: Dec. 28, 2000

(30) Foreign Application Priority Data
Jan. 6, 2000 (JP) P2000-000764
Mar. 30, 2000 (JP) P2000-093367
Mar. 30, 2000 (JP) P2000-093555

(51) Int. Cl. H04N 5/225

(52) U.S. Cl. 348/374; 348/342; 348/340

(57) ABSTRACT

An image pickup device which is comprised of a transparent cover plate, an optical low-pass filter, a solid state imaging device and a ceramic rectangular casing. The casing has a rectangular recessed portion with an opening. The solid state imaging device is provided at the base of the recessed portion. The cover plate, which is comprised of lithium niobate, is fitted into the peripheral part of the opening so that the casing is hermetically sealed. The optical filter, such as crystal or lithium niobate, is adhered to the inner surface of the cover plate. The outer surface of the cover plate is coated with an infrared cut-off layer.

### BACKGROUND OF THE INVENTION

1. Field of the Invention

The present invention relates to the mounting structure for an optical low-pass filter applied to an image pickup device, which is mounted in a digital still camera or digital video camera, to suppress moiré fringes, which are spurious image signals produced when the pitch of a periodic pattern of an object and the pitch of pixels in the image pickup device are close.

2. Description of the Related Art

Conventionally, in the art of digital still cameras and digital video cameras, there is a known apparatus in which an optical low-pass filter (a spatial frequency filter) is interposed between a taking lens and an image pickup device. The optical low-pass filter is a filter for suppressing moiré fringes caused by beats or interference between a periodic pattern of an object and a pitch of pixels in the image pickup device. The optical low-pass filter restricts a spatial frequency band of light incident on the image pickup device, thus it may improve the quality of images captured by the image pickup device.

However, in the conventional mounting of a low-pass filter, a space is required for the low-pass filter between the taking lens and the image pickup device. Accordingly, the above structure limits design flexibility along the optical axis between the taking lens and the image pickup device.

### SUMMARY OF THE INVENTION

Therefore, an object of the present invention is to provide a mounting structure for an optical low-pass filter of an image pickup device that reduces the thickness of the optical low-pass filter and gains space between the taking lens and the image pickup device to allow design flexibility.

According to the present invention, a mounting structure is provided for an optical low-pass filter applied in an image pickup device that comprises an encased solid state imaging device and optical low-pass filter. The casing is sealed hermetically by a transparent cover plate and the optical low-pass filter is mounted between the cover plate and the solid state imaging device.

Preferably, the optical low-pass filter is laminated to the surface of the cover plate that faces the solid state imaging device and its plane size is smaller than the plane size of the cover plate. The optical low-pass filter is arranged in parallel with the solid state imaging device and may comprise a plurality of birefringent plates. For example, the birefringent plates are lithium niobate or crystal and one side of a birefringent plate may be coated with an infrared cut-off layer.

Further, a birefringent plate may be arranged on the opposite side of the cover plate to the solid state imaging device and integrated with the cover plate.

In another preferable example, an infrared cut-off filter is arranged between the cover plate and birefringent plate or optical low-pass filter and adhered to both. Further, the infrared cut-off filter may be adhered to the surface of the optical low-pass filter which faces the solid state imaging device.

The cover plate may be comprised of glass, lithium niobate or an infrared cut-off filter.

According to another aspect of the present invention, an image pickup device is provided that comprises an encased solid state imaging device which is hermetically sealed by a birefringent cover plate fitted into the periphery of the case opening.

Preferably, a first birefringent plate is laminated to the surface of the birefringent cover plate facing the solid state imaging device, and is adhered to the surface by an adhesive made of an ultraviolet curing resin. Further, one side of the birefringent cover plate, or first birefringent plate, may be covered with an infrared cut-off layer. Preferably, the birefringent cover plate and first birefringent plate are arranged in parallel with the solid state imaging device and the plane size of the first birefringent plate is smaller than that of the birefringent cover plate.

The first birefringent plate and birefringent cover plate may be comprised of either crystal or lithium niobate.

Further, an infrared cut-off filter may be arranged between the birefringent cover plate and first birefringent plate.

Preferably, a second birefringent plate is arranged on a side opposite to the solid state imaging device of the birefringent cover plate.

An infrared cut-off filter may be arranged between the birefringent cover plate and second birefringent plate and adhered to both. Alternatively, one side of the birefringent cover plate or second birefringent plate may be covered with an infrared cut-off layer.

Preferably, the birefringent cover plate and second birefringent plate are arranged in parallel with the solid state imaging device and the second birefringent plate may be comprised of lithium niobate.

### BRIEF DESCRIPTION OF THE DRAWINGS

The objects and advantages of the present invention will be better understood from the following description, with reference to the accompanying drawings in which:

FIG. 1 is a front view showing an image pickup device, to which an embodiment of the present invention is applied;

FIG. 2 is a sectional view on line II-II in FIG. 1, showing the image pickup device of the embodiment;

FIG. 3 illustrates the disposition of an infrared cut-off filter to the image pickup device in the first embodiment;

FIG. 4 is a sectional view of the image pickup device in the second embodiment;

FIG. 5 is a sectional view of the image pickup device in the third embodiment;

FIG. 6 is a sectional view of the image pickup device in the fourth embodiment;

FIG. 7 is a sectional view of the image pickup device in the fifth embodiment;

FIG. 8 is a sectional view of the image pickup device in the sixth embodiment;

FIG. 9 is a sectional view of the image pickup device in the seventh embodiment;

FIG. 10 is a sectional view of the image pickup device in the eighth embodiment;

FIG. 11 is a sectional view of the image pickup device in the ninth embodiment;

FIG. 12 is a sectional view of the image pickup device in the tenth embodiment;

FIG. 13 is a sectional view of the image pickup device in the eleventh embodiment;

FIG. 14 is a sectional view of the image pickup device in the twelfth embodiment;

FIG. 15 is a sectional view of the image pickup device in the thirteenth embodiment.

### DESCRIPTION OF THE PREFERRED EMBODIMENTS

The present invention is described below with reference to embodiments shown in the drawings.

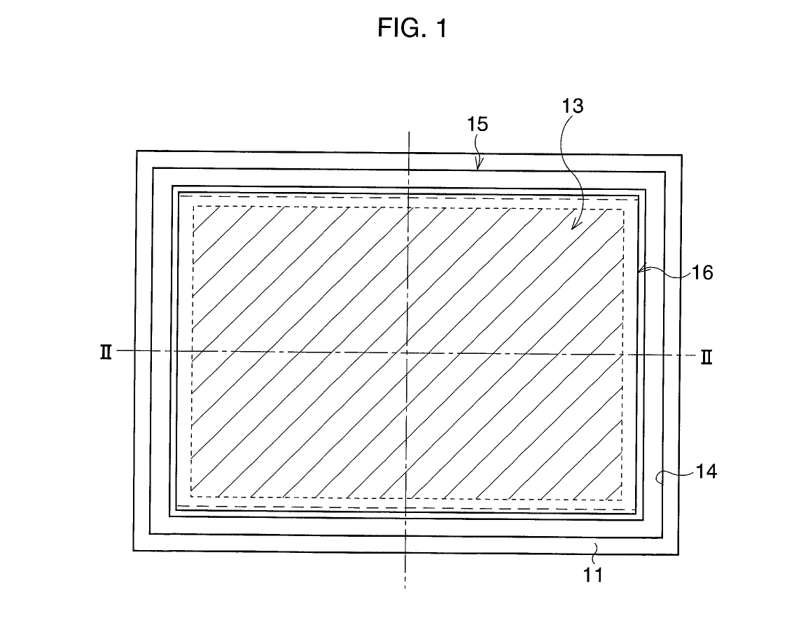

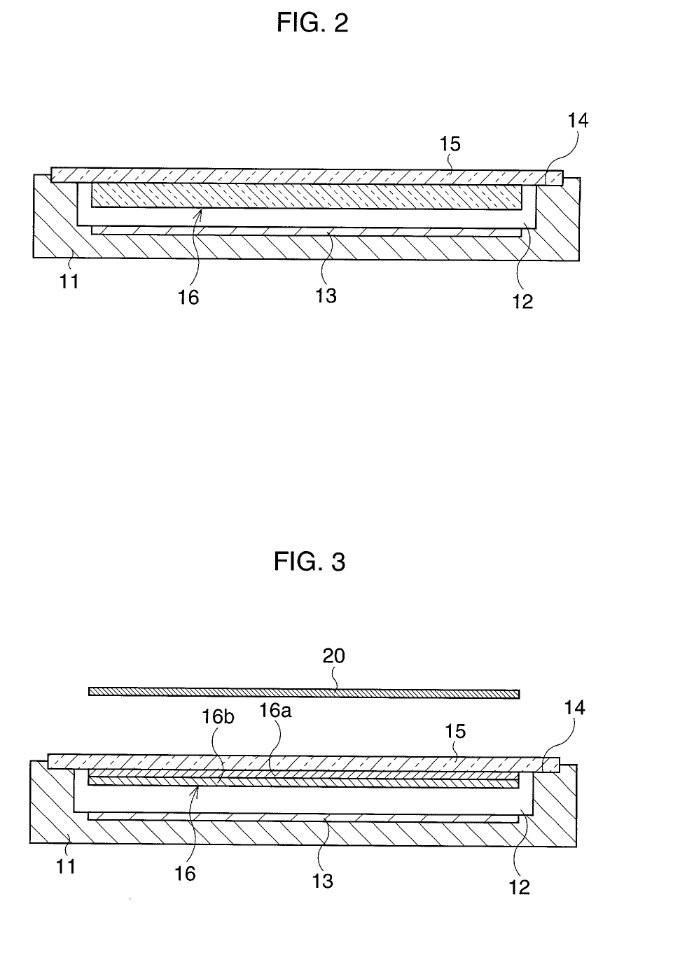

FIG. 1 and FIG. 2 show the image pickup device to which an embodiment of the present invention, a mounting structure for an optical low-pass filter made of a lithium niobate, is applied. Note that FIG. 2 is a cross section along the line II-II of FIG. 1.

A casing 11 is made in a shape of a flat ceramic box and a rectangular recessed portion 12 is formed inside the casing 11. A solid state imaging device 13 is placed on the base of the recessed portion 12. In FIG. 1, the solid state imaging device 13 is indicated as a hatched portion depicted within a phantom line. On the inner periphery of the recessed portion 12, a step 14 is formed to fit a transparent cover plate or cover glass 15 into an opening of the casing 11. The cover glass 15 is a rectangular plane of clear glass. The edges of the cover glass 15 are adhered to the step 14 by a bonding agent. The recessed portion 12 is filled with an inert gas, i.e. nitrogen gas, and is enclosed by the cover glass 15. The cover glass 15 hermetically seals the casing 11 and shields the solid state imaging device 13 from the open air.

An optical low-pass filter 16 is adhered to the surface of the cover glass 15 which faces the solid state imaging device 13. The optical low-pass filter 16 is composed of a plurality of lithium niobate (LiNbO₃) plates. However, in the first embodiment, the optical low-pass filter 16 is comprised of a pair of lithium niobate (LN) plates 16a and 16b (refer FIG. 2). The lithium niobate plates 16a and 16b are birefringent plates adhered together so that incident light is refracted in different directions by each of the LN plates 16a and 16b. The optical low-pass filter 16 is attached to the cover glass 15 by an adhesive which is made of an ultraviolet curing resin. Namely, the adhesive is applied on one side of the optical low-pass filter 16 and the optical low-pass filter 16 is placed on the cover glass 15. The optical low-pass filter 16 is then adhered to the cover glass 15 after being irradiated with ultraviolet radiation.

The optical low-pass filter 16 is a rectangular flat plate. The plate is approximately the same plane size as the solid state imaging device 13 and is smaller than the cover glass 15, by a certain amount. The optical low-pass filter 16 is arranged in parallel with the solid state imaging device 13 and the distance or gap between the optical low-pass filter 16 and the solid state imaging device 13 is approximately equal to the thickness of the optical low-pass filter 16.

Note that a plurality of crystal plates may be used for the optical low-pass filter 16. However, the optical low-pass filter comprised of a plurality of crystal plates is thicker than that comprising a plurality of LN plates. Therefore, a casing applicable to an optical low-pass filter of crystal plates requires a larger depth for the recessed portion so that the optical low-pass filter does not interfere with the solid state imaging device. Contrarily, in the first embodiment, since the optical low-pass filter 16 comprised of LN plates is far thinner than the low-pass filter comprised of crystal plates, the inside measurements of the recessed portion can be varied, thus there is an advantage of flexibility when selecting a casing.

Of course, the form and measurements of the optical low-pass filter and the distance between the low-pass filter and the solid state imaging device can be altered as required.

FIG. 3 illustrates disposition of an infrared cut-off filter 20 to the image pickup device shown in FIG. 1 and FIG. 2.

The infrared cut-off filter 20 is disposed between the taking lens (not shown) and the cover glass 15, and it is supported by a support member (not shown). The infrared cut-off filter (infrared absorption filter) 20 is a rectangular plate parallel to the cover glass 15 and its plane size is about the size of the optical low-pass filter 16. The infrared cut-off filter 20 is concentric with the optical axis of the taking lens. Light penetrating through the taking lens is incident on the image pickup device via the infrared cut-off filter 20. The infrared region light component is absorbed while the incident light passes through the infrared cut-off filter 20. With the infrared cut-off filter 20, the solid state imaging device 13 may capture an image in an object's natural color.

As discussed above, in the first embodiment of the present invention, the optical low-pass filter 16 is applied on the inner surface of the cover glass 15 disposed on the casing 11 of the image pickup device. Namely, the optical low-pass filter 16 is arranged inside the casing 11, between the cover glass 15 and the solid state imaging device 13, and the space conventionally occupied by the optical low-pass filter between the taking lens and the image pickup device can be released with only a small change to the size of the image pickup device. Consequently, this arrangement provides designers with various design options along the optical axis between the taking lens and the image pickup device 13 and also simplifies the structure of the optical system utilized in the image pickup device. Further, the lithium niobate plates have a property, which attracts dust and the image quality of the solid state imaging device deteriorates. However, in the first embodiment, the optical low-pass filter 16 is arranged inside the recessed portion 12, inside the casing 11, and the recessed portion 12 is sealed hermetically by the cover glass 15 so that the optical low-pass filter comprised of LN plates 16a and 16b is shielded from dust and the image quality of the image pickup device is improved.

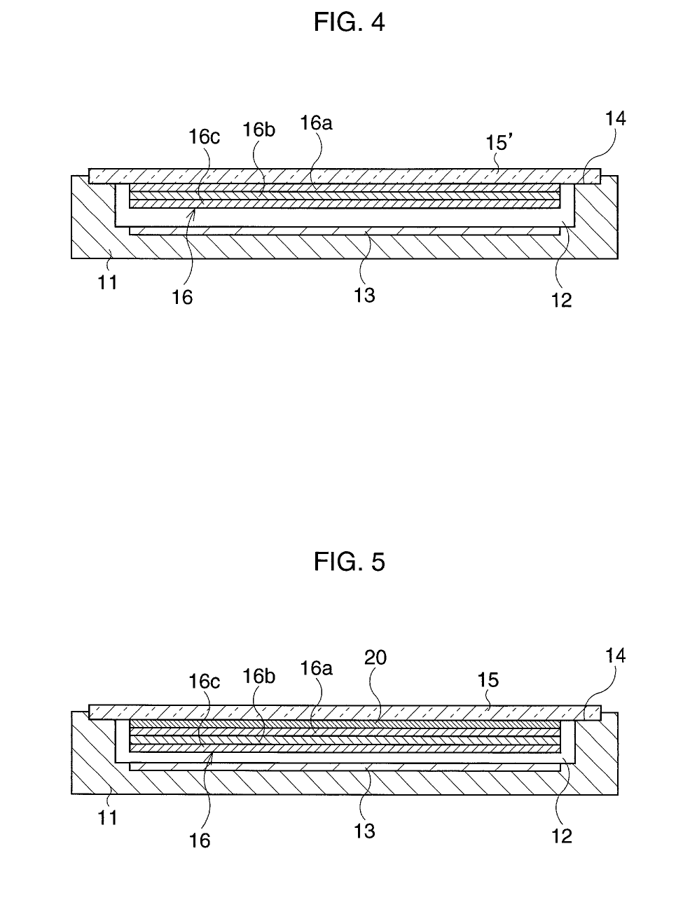

A second embodiment of the present invention is explained with reference to FIG. 4 as follows:

Structure of the second embodiment is almost the same as the first embodiment. Therefore, only structure dissimilar to the first embodiment is explained.

In the second embodiment, an infrared cut-off filter 15′ is used in place of the cover glass 15. For the optical low-pass filter 16, a plate comprised of three laminated lithium niobate (LN) plates 16a, 16b and 16c, is applied.

According to the above structure, the same effect is obtained as in the first embodiment. It further enables space to be released between the taking lens and image pickup device to allow design flexibility, since it eliminates the necessity for the infrared cut-off filter 20.

FIG. 5 illustrates content of third embodiment. The third embodiment is explained in the following with reference to FIG. 5.

In the third embodiment, the infrared cut-off filter 20, which in the first embodiment is disposed on the outside of the casing 11, above the cover glass 15, is disposed on the inside of the casing 11 below the cover glass 15, along with the optical low-pass filter 16. The rest of the structure is the same as the first embodiment.

As shown in FIG. 5, the infrared cut-off filter 20 is adhered to the surface of the cover glass 15 facing the solid state imaging device 13. The optical low-pass filter 16 is adhered to the infrared cut-off filter 20 on the solid state imaging device 13 side and is comprised of three lithium niobate plates, laminated and adhered together. According to the above structure, the same effect as the second embodiment is obtained. Further, according to the third embodiment, the quality of the infrared cut-off filter 20, which has moisture absorbent properties, is prevented from deterioration caused by humidity, since the infrared cut-off filter 20 is hermetically sealed inside the casing 11 and sandwiched between the cover glass 15 and low-pass filter 16.

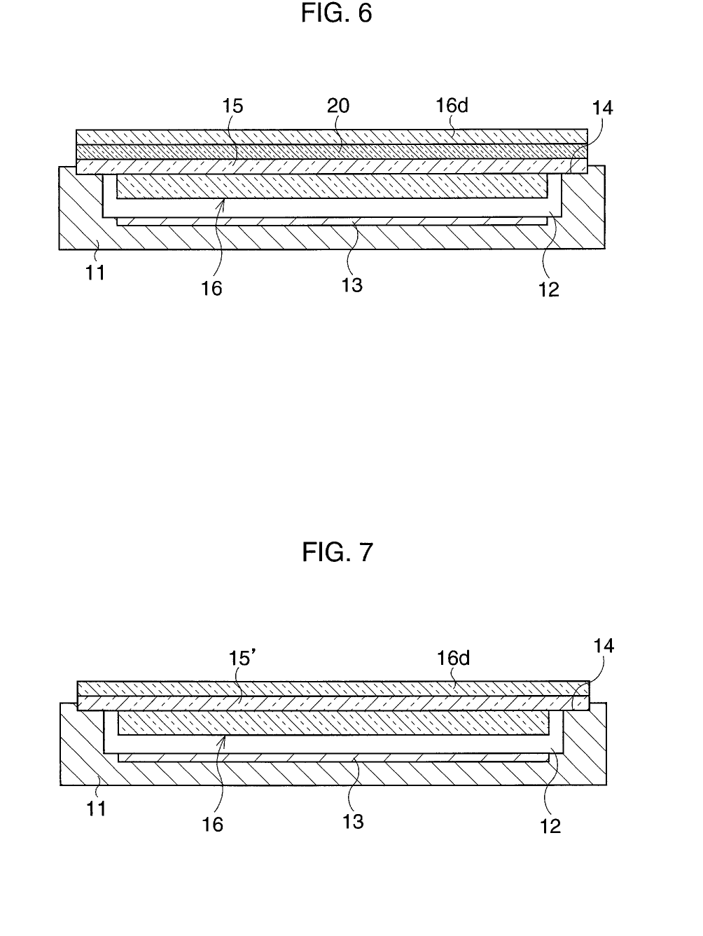

The fourth embodiment of the present invention is explained with reference to FIG. 6.

In the fourth embodiment, the infrared cut-off filter 20 is adhered to the outer surface (the surface opposite to the solid state imaging device 13) of the cover glass 15 of the first embodiment, and a lithium niobate (LN) plate 16d is further laid on the outer surface of the infrared cut-off filter 20 to which LN plate 16d is adhered. Namely, in the fourth embodiment, each member is laminated in the following order: the LN plate 16d, infrared cut-off filter 20, cover glass 15 and optical low-pass filter 16, from the outer to the inner side of the image pickup device (in the figure from top to bottom) Therefore, dissimilar to the first embodiment, special structure for an infrared cut-off filter is unnecessary.

Though, in the present embodiment, the optical low-pass filter 16 is comprised of a plurality of lithium niobate plates, the optical low-pass filter may also be comprised of a combination of lithium niobate and crystal plates. The LN plate 16d functions as the optical low-pass filter, a filter which passes bands of a low spatial frequency, when it cooperates with one of the LN plates in the low-pass filter 16. Therefore, the number of LN plates of the optical low-pass filter 16 may be reduced by increasing the number of the LN plate 16d.

As described above, according to the fourth embodiment, since the optical low-pass filter 16 is placed between the cover glass 15 and the solid state imaging device 13, the space previously required the for low-pass filter 16, between the taking lens and image pickup device, is reduced. This improves design flexibility along the optical axis between the taking lens and the image pickup device. Further, since the infrared cut-off filter 20 is sandwiched between the cover glass 15 and LN plates 16d, absorption of moisture is prevented and quality of the infrared cut-off filter 20 is maintained. Note that the fourth embodiment is effective when a large number of LN plates are required for the low-pass filter, and the recessed portion is not deep enough to adopt the structure of the third embodiment, shown in FIG. 5.

The fifth embodiment of the present invention is explained with reference to FIG. 7.

In the fifth embodiment, a lithium niobate (LN) plate 16d is laid on and adhered to the outer surface of the infrared cut-off filter 15′ of the second embodiment, which also functions as a cover glass. The infrared cut-off filter 15′ is shielded from the open air by the LN plate 16d, thus a problem cannot be induced by the absorption of moisture. As described above, according to the fifth embodiment, an effect similar to the fourth embodiment is obtained. Moreover, in the fifth embodiment, the infrared cut-off filter is also used as the cover glass, so the space is released even further.

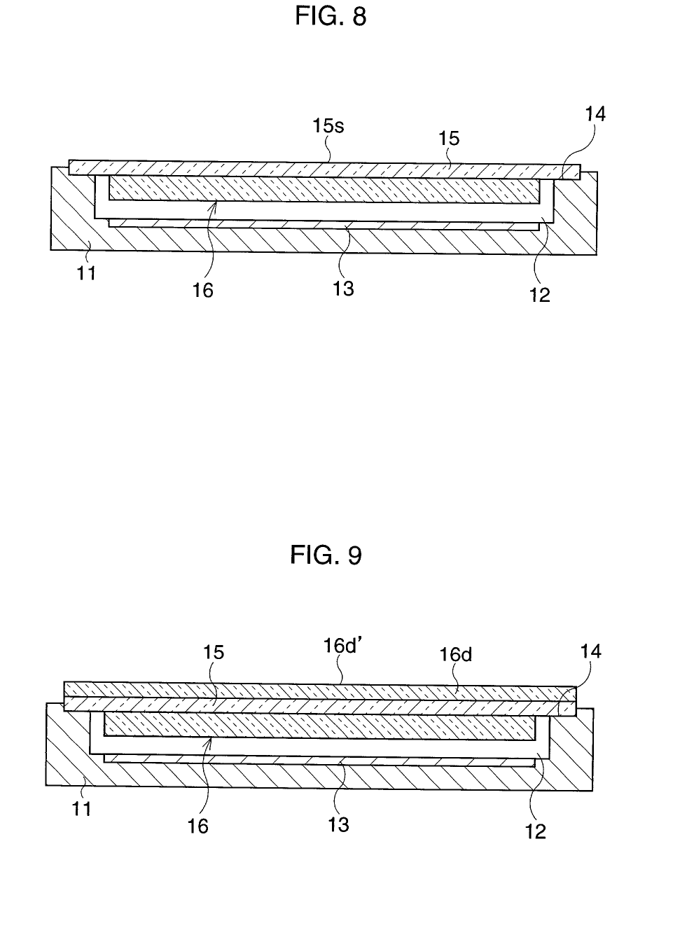

FIG. 8 is a schematic cross section of an image pickup device of a sixth embodiment.

In the sixth embodiment, the outer surface 15s of the cover glass 15 of the first embodiment is coated with an infrared cut-off layer. The same effect as the first embodiment is obtained by the sixth embodiment. Further, in the sixth embodiment, space between the taking lens and image pickup device is increased and design flexibility along the optical axis is improved, since the infrared cut-off filter is replaced by the infrared cut-off layer coating. Besides, there is no deterioration caused by the absorption of moisture into the infrared cut-off layer coating.

FIG. 9 is a schematic cross section of an image pickup device of a seventh embodiment.

In the seventh embodiment, an LN plate 16d is adhered to the outer surface of the cover glass 15, which is described in the first embodiment, and the outer surface 16d′ of the LN plate 16d is coated with an infrared cut-off layer. The structure of the seventh embodiment has the same effect as the fourth embodiment. Further, in the seventh embodiment, as well as the sixth embodiment, space for an infrared cut-off filter 20 is not required between the taking lens and image pickup device and design flexibility along the optical axis is increased, as the infrared cut-off filter is replaced by the infrared cut-off layer coating. Thus, quality deterioration induced by the absorption of moisture is resolved.

Note that, in the first and second embodiments, the optical low-pass filter is described as being comprised of two or three LN plates for clarity and the above numbers are only an example and are not limited. Namely, the number of the LN plates may be more than three or one with combination with other types of birefringent plates. In the third and fourth embodiments, the infrared cut-off filter is placed between the cover glass 15 and the optical low-pass filter 16 or LN plate 16d. However, when the optical low-pass filter comprises a plurality of LN plates, the infrared cut-off filter may be inserted between two LN plates and adhered to both. Further, as in the third embodiment, when the infrared cut-off filter is disposed inside the casing 11, the infrared cut-off filter 20 may be adhered to the surface of the optical low-pass filter 16 that faces the solid state imaging device 13.

Though in the sixth and seventh embodiments, the infrared cut-off layer coating is applied to the outer surface of the cover glass 15 or LN plate 16d, it may be applied to the surface facing the solid state imaging device 13, of the optical low-pass filter 16. Further, when the optical low-pass filter 16 comprises a plurality of LN plates, the infrared cut-off layer coating may be applied to a surface between two LN plates, at the same time that the matching coat is applied for adhering the LN plates. Furthermore, the infrared cut-off layer coating may be applied to a surface of the cover glass 15 in the seventh embodiment.

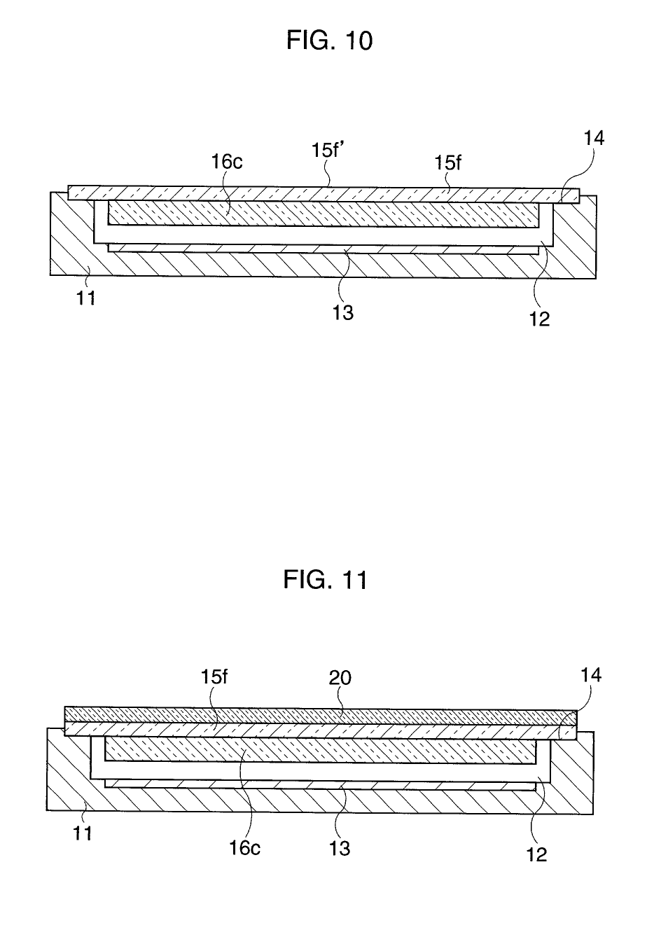

An eighth embodiment of the present invention is explained as follows, with reference to FIG. 10.

In the eighth embodiment, the cover glass 15 is replaced by a lithium niobate (LN) plate (a birefringent cover plate) 15f. On the surface of the LN cover plate 15f facing the solid state imaging device 13, a crystal plate (a first birefringent plate) 16c is adhered.

The LN cover plate 15f and the crystal plate 16c function as an optical low-pass filter. The ultraviolet curing resin is applied on one side of the crystal plate 16c and it is adhered onto the LN cover plate 15f after being irradiated with ultraviolet radiation.

The crystal plate 16c is a flat plate about the same size as, and arranged parallel to, the solid state imaging device 13. At the same time, the crystal plate 16c is slightly smaller in area than the LN cover plate 15f. Distance between the crystal plate 16c and solid state imaging device 13 is approximately the same as the thickness of the crystal plate 16c.

Further, the infrared cut-off layer coating, which absorbs infrared rays, is applied to the outer surface (the surface in the taking lens side) 15f′ of the LN cover plate 15f. Note that, the form and size of the crystal plate 16c and the distance between the crystal plate 16c and solid state imaging device 13 may be modified as required.

As described above, according to the eighth embodiment, space for the cover glass is reduced by replacing a normal cover glass with a lithium niobate plate 15, which has birefringent properties and functions as an optical low-pass filter in cooperation with the crystal plate. Further, since the outer surface 15f′ of the LN cover plate 15f is coated with the infrared cut-off layer, there is no need to arrange an infrared cut-off filter between the taking lens and image pickup device. Therefore, more space is available between the taking lens and image pickup device and design flexibility is improved. It also simplifies the structure around the image pickup device. Furthermore, a lithium niobate plate is more easily adhered to a casing than an infrared cut-off filter 151 mentioned in the second embodiment. Thus the above structure improves the yield rate of the product.

The ninth embodiment of the present invention is explained with reference to FIG. 11. Some structures of the ninth embodiment are similar to the eighth embodiment, therefore only structures dissimilar to the eighth embodiment are explained.

In the ninth embodiment, an infrared cut-off filter 20 is attached to the outer surface 15f′ of the LN cover plate 15f in place of an infrared cut-off layer coat. With the above structure, a similar effect to the eighth embodiment is obtained. Although the ninth embodiment requires space for the infrared cut-off filter 20 between the taking lens and image pickup device, an infrared cut-off filter outperforms an infrared cut-off layer coat for absorbing infrared rays. Therefore, the quality of the image captured by the solid state imaging device 13 may improve.

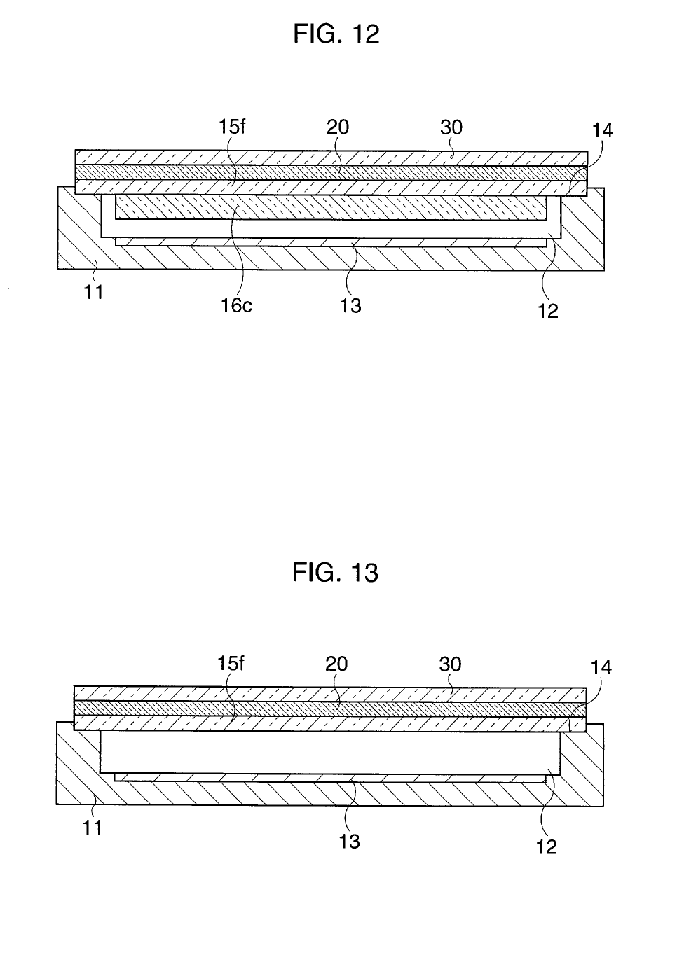

FIG. 12 illustrates the image pickup device of the tenth embodiment of the present invention and is explained as follows:

In the tenth embodiment, a lithium niobate (LN) plate (a second birefringent plate) 30 is attached to the outer surface of the infrared cut-off filter 20 of the ninth embodiment. The LN plate 30, LN cover plate 15f and crystal plate 16c are placed in a certain direction so that incident light is refracted in different directions by the LN plate 30, LN cover plate 15f and crystal plate 16c and efficiently functions as an optical low-pass filter.

With the tenth embodiment, an effect similar to the eighth and ninth embodiment is obtained. Further, since a plurality of LN plates are utilized in the tenth embodiment, the properties of the optical low-pass filter outperform the eighth and ninth embodiments, thus image quality of the solid state imaging device is improved.

With reference to FIG. 13, the eleventh embodiment of the present invention is explained.

The image pickup device in the eleventh embodiment corresponds to a device from which the crystal plate 16c, of the tenth embodiment, is removed. With the eleventh embodiment, an effect similar to the tenth embodiment is obtained. Moreover, with the structure of the eleventh embodiment, the manufacturing process to attach the crystal plate 16c inside the casing 11 is omitted and the production costs decrease.

In the tenth and eleventh embodiment, an infrared cut-off filter 20 is arranged between the LN cover plate 15f and LN plate 30, thus the infrared cut-off filter 20 is prevented from deterioration, caused by absorption of moisture, and can be thinned down.

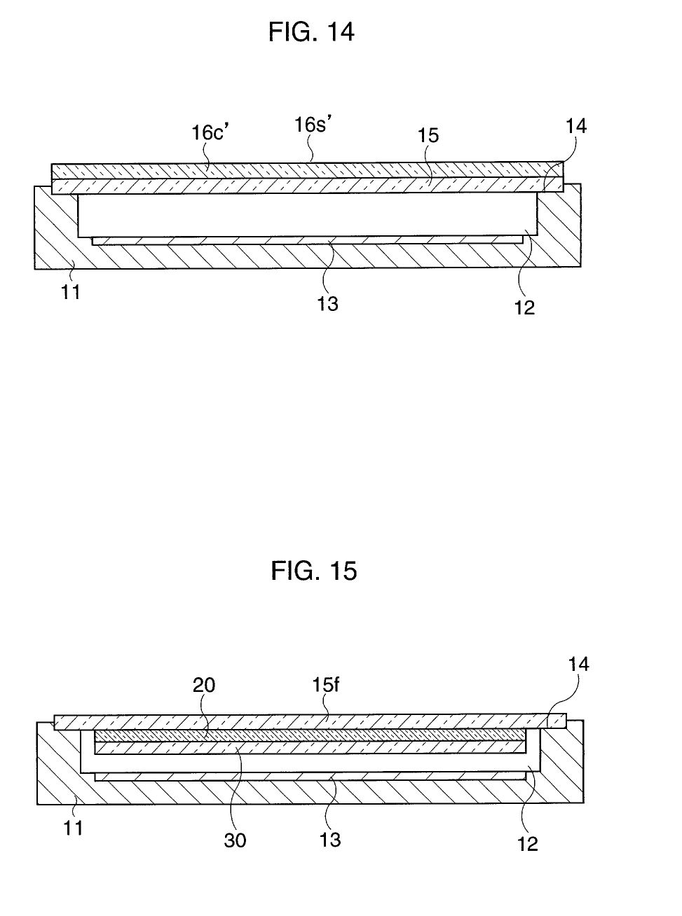

The twelfth embodiment of the present invention is explained below with reference to FIG. 14.

The image pickup device in the twelfth embodiment corresponds to the image pickup device of the eleventh embodiment from which the infrared cut-off filter 20 is removed and a crystal plate 16c′ is attached to the outer surface of the LN cover plate 15f. Further, the infrared cut-off filter 20 of the eleventh embodiment is replaced by an infrared cut-off layer coating on the outer surface 16s′ of the crystal plate 16c′. In this case, the LN cover plate 15f and crystal plate 16c′ cooperatively function as an optical low-pass filter. Consequently, in the twelfth embodiment, an effect similar to the eleventh embodiment is obtained. Moreover, space for an infrared cut-off filter is not required between the taking lens and image pickup device.

The thirteenth embodiment of the present invention is explained with reference to FIG. 15.

In the thirteenth embodiment, the infrared cut-off filter 20 is adhered onto the inner surface of the LN cover plate 15f and a lithium niobate (LN) plate 30 is attached on the inner surface of the infrared cut-off filter 20. Since the infrared cut-off filter 20 and the LN plate 30 are arranged inside the casing 11, space between the taking lens and image pickup device may be used more effectively. Further, the infrared cut-off filter 20 efficiently absorbs infrared rays made incident by the taking lens. Furthermore, the infrared cut-off filter 20 is protected from moisture, as the filter 20 is sealed in the casing 11.

Note that, in the eighth through tenth and twelfth embodiment, each of the crystal plates 16c and 16c′ may be comprised of one or a plurality of LN plates.

In the eighth and twelfth embodiment, though an infrared cut-off layer coat is applied on the outer surface of the LN cover plate 15f or crystal plate 16c′, it may be applied onto the other (inner) surface of the LN cover plate 15f or crystal plate 16c′, i.e., the surface which faces the solid state imaging device 13.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application Nos. 2000-000764 (filed on Jan. 6, 2000), 2000-093367 (filed on Mar. 30, 2000) and 2000-093555 (filed on Mar. 30, 2000), which is expressly incorporated herein, by reference, in their entireties.

1. A mounting structure for an optical low-pass filter for an image pickup device, wherein said image pickup device comprises:
a casing having an opening;
a solid state imaging device provided inside said casing; and
a transparent cover plate that covers said solid state imaging device and hermetically seals said casing by fitting said cover plate into a periphery of said opening; and
an optical low-pass filter is mounted inside said casing in such a manner that said optical low-pass filter is arranged between said cover plate and said solid state imaging device.

2. A mounting structure for an optical low-pass filter according to claim 1, wherein said optical low-pass filter is laminated to a surface of said cover plate which faces said solid state imaging device.

3. A device according to claim 2, wherein said optical low-pass filter is adhered to said surface by an ultraviolet curing adhesive.

4. A mounting structure for an optical low-pass filter according to claim 1, wherein a plane size of said optical low-pass filter is smaller than a plane size of said cover plate.

5. A mounting structure for an optical low-pass filter according to claim 1, wherein said optical low-pass filter is arranged in parallel with said solid state imaging device.

6. A mounting structure for an optical low-pass filter according to claim 1, wherein said optical low-pass filter comprises a plurality of birefringent plates.

7. A mounting structure for an optical low-pass filter according to claim 6, wherein said birefringent plates comprise a lithium niobate plate.

8. A mounting structure for an optical low-pass filter according to claim 6, wherein at least one side of one of said birefringent plates is coated with an infrared cut-off layer.

9. A mounting structure for an optical low-pass filter according to claim 1, wherein at least one birefringent plate is arranged on a side of said cover plate, opposite to said solid state imaging device, and integrated with said cover plate.

10. A mounting structure for an optical low-pass filter according to claim 9, wherein said birefringent plate is arranged in parallel with said cover plate.

11. A mounting structure for an optical low-pass filter according to claim 9, wherein an infrared cut-off filter is arranged between said birefringent plate and said cover plate and adhered to each of said birefringent plate and said cover plate.

12. A mounting structure for an optical low-pass filter according to claim 9, wherein said birefringent plate comprises a lithium niobate plate.

13. A mounting structure for an optical low-pass filter according to claim 9, wherein at least one side of one of said birefringent plates is coated with an infrared cut-off layer.

14. A mounting structure for an optical low-pass filter according to claim 1, wherein an infrared cut-off filter is arranged between said optical low-pass filter and said cover plate and adhered to each of said optical low-pass filter and cover plate.

15. A mounting structure for an optical low-pass filter according to claim 1, wherein an infrared cut-off filter is adhered to a surface of said optical low-pass filter which faces said solid state imaging device.

16. Amounting structure for an optical low-pass filter according to claim 1, wherein said cover plate comprises glass.

17. A mounting structure for an optical low-pass filter according to claim 1, wherein said cover plate comprises an infrared cut-off filter.

18. A image pickup device comprising:
a casing having an opening;
a solid state imaging device provided inside said casing; and
a birefringent cover plate that covers said solid state imaging device and hermetically seals said casing from the open air by fitting said birefringent cover plate into a periphery of said opening.

19. A device according to claim 18, wherein at least one first birefringent plate is laminated to a surface of said birefringent cover plate, which faces said solid state imaging device.

20. A device according to claim 19, wherein said first birefringent plate is adhered to said surface by an ultraviolet curing adhesive.

21. A device according to claim 19, wherein at least one side of one of said birefringent cover plate and said first birefringent plate is covered with an infrared cut-off layer.

22. A device according to claim 19, wherein each of said birefringent cover plate and said first birefringent plate is arranged in parallel with said solid state imaging device.

23. A device according to claim 19, wherein a plane size of said first birefringent plate is smaller than a plane size of said birefringent cover plate.

24. A device according to claim 19, wherein said first birefringent plate comprises a crystal plate.

25. A device according to claim 19, wherein said first birefringent plate comprises a lithium niobate plate.

26. A device according to claim 19, wherein an infrared cut-off filter is arranged between said birefringent cover plate and said first birefringent plate.

27. A device according to claim 18, wherein said birefringent cover plate comprises a lithium niobate plate.

28. A device according to claim 18, wherein a second birefringent plate is arranged in a side of said birefringent cover plate opposite to said solid state imaging device.

29. A device according to claim 28, wherein an infrared cut-off filter is arranged between said birefringent cover plate and said second birefringent plate and adhered to each of said birefringent cover plate and said second birefringent plate.

30. A device according to claim 28, wherein at least one side of one of said birefringent cover plate and said second birefringent plate is covered with an infrared cut-off layer.

31. A device according to claim 28, wherein each of said birefringent cover plate and said second birefringent plate is arranged in parallel with said solid state imaging device.

32. A device according to claim 28, wherein said second birefringent plate comprises a lithium niobate plate.
